(19) United States
(12) Patent Application Publication
(10) Pub. No.: US 2003/0092838 A1
(43) Pub. Date: May 15, 2003

(54) Supramolecular polymer composition, a method of manufacturing it, and a cable including such a composition

(76) Inventors: Lionel Fomperie, Auffargis (FR); Laurent Bouteiller, Bourg la Reine (FR); Olivier Colombani, Palaiseau (FR)

Correspondence Address: SOFER & HAROUN, L.L.P., 317 Madison Avenue, Suite 910, New York, NY, 10017, US

(21) Appl. No.: 10/251,619

(22) Filed: Sep. 20, 2002

(30) Foreign Application Priority Data
Oct. 3, 2001 (FR) 01 12934

(51) Int. Cl. C08L 51/04

(52) U.S. Cl. 525/71

(57) ABSTRACT

The present invention relates to a supramolecular polymer composition and to a method of manufacturing such a composition in particular for use in making cables. The supramolecular polymer composition of the invention comprises:

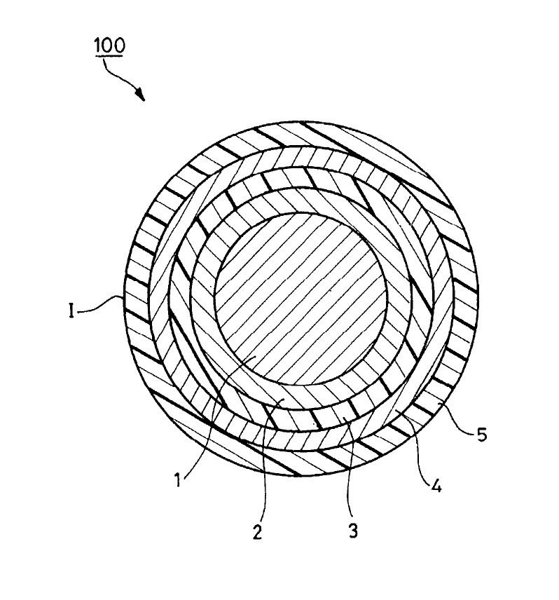

a first polymer chain on which at least one first functional group is grafted; and

a second polymer chain on which at least one second functional group is grafted;

the first and second functional groups being associated with each other by at least one intermolecular bond of the hydrogen type.

The present invention relates to a supramolecular polymer composition and to a method enabling such a composition to be manufactured, in particular for use in cable accessories or as a sheath and/or insulation for telecommunications cables or power cables.

### BACKGROUND OF THE INVENTION

In this type of application, compositions are required that present good thermomechanical properties.

In conventional manner, the compositions which best satisfy this criterion are based on cross-linked polymers in which a three-dimensional structure is formed by covalent bonds between chains.

Compositions based on cross-linked polymers are obtained using silanes such as vinyl silane which are often grafted on the polymers. Such a cross-linking method implies in particular that after extrusion the composition must be immersed in a bath of hot water. Consequently, since such immersion is particularly expensive and requires special infrastructure, the time required to make cables containing such a composition is long and poorly compatible with industrial needs. In addition, the resulting composition is generally difficult to recycle because of the presence of cross-linking bridges which are bonds of the C—Si—O—Si—C type.

Other compositions based on cross-linked polymers are obtained by the peroxide method. After extrusion, this requires the peroxide to be decomposed under gas pressure and at high temperature in long “vulcanizing” tubes. Cross-linking relies on this decomposition process. In addition, the gas pressure can spoil certain properties of polymers (deforming insulation, . . . ) Consequently, the peroxide methods leads to compositions that are expensive and of limited applicability. Furthermore, the resulting composition is generally difficult to recycle because of covalent bonds of the C—C type.

In addition, cross-linking agents such as silane or peroxide are introduced either during “compounding”, i.e. while the composition is being made up in an internal mixer, or else at the beginning of the following step of extrusion. Extrusion temperature must be lower than the decomposition temperature of peroxide or the condensation temperature of silane which would lead to the composition cross-linking early, thereby degrading its final properties. The composition is therefore rather viscous, which means that the speed of extrusion is quite slow.

Thus, prior art compositions are obtained after a series of steps that are complex and expensive and such compositions are not very suitable for recycling.

### OBJECTS AND SUMMARY OF THE INVENTION

An object of the present invention is to develop a composition that is less expensive than those based on known cross-linked polymers, that is easy to manufacture, that can be extruded quickly, that is recyclable, and that possesses good thermomechanical properties.

In a first aspect, the present invention thus provides a supramolecular polymer composition comprising:

a first polymer chain on which at least one first functional group is grafted; and

a second polymer chain on which at least one second functional group is grafted;

said first and second functional groups being associated with each other by at least one intermolecular bond of the hydrogen type.

A supramolecular polymer composition of the invention comprises at least two polymer chains either belonging to the same polymer or else to two distinct polymers. The composition can make use of a vast range of polymers which, depending on the intended application, may be with or without branching, with or without a filler, and preferably selected from polymers that are the most widespread and the least expensive. Similarly, appropriate functional groups are selected (low cost, ease of grafting on the chains, . . . ).

The polymer(s) of the invention possess(es) a three-dimensional structure that is not constituted by covalent bonds between chains like in cross-linked polymers, but rather by intermolecular bonds of the hydrogen type. Thus, the supramolecular polymer composition of the invention forms a supramolecular structure relying on intermolecular bonds that result for example from electrostatic attraction between two partially-charged molecules of opposite sign, one belonging to the first functional group of the invention and the other to the second functional group.

Intermolecular bonds can be strong enough to obtain a composition having high resistance to creep with temperature and ensuring good stability in the long term. This is particularly advantageous when manufacturing sheaths or insulation for cables. In addition, the composition of the invention makes it easy to obtain finished products having a high degree of flexibility.

Unlike the prior art, the supramolecular polymer composition of the invention can be manufactured without requiring immersion in water or special heat treatments. The step of grafting the first and second functional groups can be performed at the time of compounding and at ambient temperature. This makes it possible to minimize the number of manufacturing steps and to use pre-existing equipment. In this way, costs are kept down and manufacture is simple and fast. Unlike the prior art, viscosity is not increased, so it is possible to increase the speed of extrusion.

In addition, an intermolecular bond breaks more easily than a covalent bond, for example, during an extrusion process that combines a rise in temperature with a high degree of shear.

Once such stresses have come to an end, the bonds reform. Thus, the building-up of the supramolecular structure in a composition of the invention can be both reversible and spontaneous (no need for a catalyst). In this manner, the composition of the invention makes it possible to obtain finished products that are suitable for recycling: since the initial properties of the basic ingredients in the invention are not spoilt, they can be reused. In particular, the polymer(s) of the invention is/are easier to recycle than cross-linked polymers of the prior art.

In a preferred embodiment, the composition of the invention may further comprise a third functional group associated with at least one of said first and second functional groups by at least one intermolecular bond of the hydrogen type.

This makes it possible in particular to modify the conditions under which intermolecular bonds dissociate in order to reinforce the supramolecular structure.

Advantageously, said functional groups may be selected from ureas, and preferably from biureas.

Urea compounds such as biureas are groups of small molecules that are presently the subject of fundamental research. Biureas are described in particular by S. Boileau et al. in “Soluble supramolecular polymers based on urea compounds”, New Journal of Chemistry, 2000, 24, pp. 845-848. That document discloses certain methods of synthesizing symmetrical biureas (scheme 1c) for example by reacting a diisocyanate with a suitable amine. In a solvent medium such as heptane, carbon tetrachloride, or dichloromethane, it is mentioned that such biureas are liable to associate with one another by means of hydrogen bonds coming from the interaction of an oxygen atom with two hydrogen atoms (scheme 1d).

A supramolecular polymer composition of the invention is thus obtained by grafting these small molecules of the biurea type on the first and second polymer chains, and by creating conditions that are favorable for hydrogen bonds to form.

In a preferred embodiment, the biurea comprises a group known as a “spacer” group disposed between two urea functions, said spacer group being 1-methyl 2,4-phenylene.

Preferably, the first functional group is identical to said second functional group.

It may be advantageous to graft identical biureas on the first and second polymer chains of the invention. Firstly it is already demonstrated that they associated, and secondly that reduces the number of different ingredients in the composition of the invention.

In the invention, each of said first and second polymer chains belongs to a polymer selected from: amorphous polymers; at least partially crystalline polymers; and preferably homopolymers of ethylene; copolymers of ethylene and vinyl acetate; and silicones.

A crystalline polymer gives the composition of the invention mechanical properties that are good since it contributes to reinforcing the structure. A crystalline polymer may be a homopolymer of an olefin having two distinct atoms of carbon or a copolymer of two olefins each having two distinct atoms of carbon, said olefins possibly being the following, for example: ethylene; propylene; butene; pentene; hexene; isobutylene; methyl-butene; methyl-pentene; dimethyl-butene; or ethyl-butene. In general, polyethylene is used, preferably high density polyethylene (PEHD) since these are polymers that are widely available and therefore low in cost, and since they possess dielectric characteristics that are compatible with the specifications necessary for making materials for power cables.

An amorphous polymer confers flexibility on the composition of the invention. Examples of such polymers suitable for entering into the composition of the invention include copolymers of an ethylene-unsaturated compound such as ethylene and an unsaturated ester, such as copolymers of ethylene and vinyl acetate (EVA), copolymers of ethylene and vinyl propionate, copolymers of ethylene and allyl acetate, and copolymers of ethylene and allyl propionate.

It is preferable to use EVA copolymer because of its properties of flexibility, and its capacity of accepting large amounts of filler, thus giving rise to a material that is fireproofed. In a variant, it is possible to select copolymers of ethylene and butyl acrylate (EBA), copolymers of ethylene and ethyl acrylate (EEA), copolymers of ethylene and methyl acrylate (EMA), ethylene-propylene-diene monomer terpolymers (EPDM), and copolymers of ethylene and propylene (EPR). The composition may also contain a functionalized polymer of the polyethylene type (PE), a copolymer of ethylene such as an EVA or an EPR, a polypropylene (PP), or a copolymer of propylene carrying functions, e.g. grafted functions such as epoxy, anhydride, acrylic acid.

Advantageously, the first functional group may carry at least a first group that reacts selectively with the first polymer chain, and the second functional group may carry at least a second group that reacts selectively with the second polymer chain, the first and second reactive groups being selected from: alkoxysilanes; vinyls; silanes; epoxies; amines; and isocyanates.

The first and second reactive groups vary accordingly, depending on the nature of the polymer chains carrying the grafting.

In a preferred embodiment, the first functional group carries a single first group that reacts selectively with the first polymer chain, and the second functional group carries a single second group that reacts selectively with the second polymer chain, the first and second reactive groups being selected from: alkoxysilanes; vinyls; silanes; epoxies; amines; and isocyanates.

A single graft per functional group gives greater freedom in setting the conditions for dissociating intermolecular bonds. In an embodiment, the composition of the invention includes a grafting catalyst selected from: amines; compounds based on platinum; and compounds based on tin, preferably salts of tin.

In a preferred embodiment, the composition of the invention may further comprise at least one filler.

The filler may be a reactive filler such as surface-reactive magnesia, alumina, kaolin, and mica, or it may be a non-reactive filler such as chalk, carbon black, non-reactive magnesia, and natural or synthetic clay.

In a preferred embodiment, a composition of the invention comprises a first EVA polymer chain having at least a first biurea carrying an alkoxysilane grafted thereon, and a second EVA polymer chain having at least a second biurea carrying an alkoxysilane grafted thereon.

The present invention also provides a method of manufacturing a supramolecular polymer composition containing a plurality of functional groups, the method comprising:

a step of grafting a first of said functional groups on a first polymer chain, and a step of grafting a second of said functional groups on a second polymer chain; and

an “association” step of associating said first and second functional groups by at least one intermolecular bond of the hydrogen type.

The method of manufacture of the invention presents the advantages mentioned above:

working takes place at ambient temperature without immersion in water and using existing installations; and

the resulting composition can be extruded at higher speed because of the low viscosity of the composition.

The grafting step and the association step are preferably performed at the time of compounding.

Since, in addition, the supramolecular polymer composition is obtained in a manner that is both reversible and spontaneous, a second association step may take place after extrusion. During the association step of the method of the invention, intermolecular bonds may form between one and/or the other of the grafted functional groups and non-grafted groups, thereby reinforcing the supramolecular structure of the composition.

Advantageously, said functional groups may be selected from ureas and preferably from biureas, and said first and second functional groups are preferably identical.

In a manufacturing method of the invention, the grafting step may be performed in the presence of a grafting catalyst selected from: amines; compounds based on platinum; and compounds based on tin, preferably salts of tin.

In the invention:

each of said first and second polymer chains belongs to a polymer selected from: elastomers; thermoplastic polymers; and preferably: homopolymers of ethylene; copolymers of ethylene and vinyl acetate; and silicones;

said first functional group comprises a first group that is selectively reactive with said first polymer chain; and

said second functional group comprises a second group that is selectively reactive with said second polymer chain;

said reactive groups preferably being identical and selected from: alkoxysilanes; vinyls; silanes; epoxies; amines; and isocyanates.

In one method of manufacture of the invention, the grafting step is performed in the presence of peroxide.

For example, the peroxide is preferably selected so as to graft reactive groups such as vinyls on a polyolefin such as polyethylene.

In one method of manufacture of the invention, at least one filler may be added during one of the grafting and association steps.

The composition of the invention may advantageously be extruded in a manner suitable for producing various finished products that benefit from the mechanical properties and the resistance to high temperatures that are possessed by the composition of the invention.

As examples of such finished products, mention can be made of power or telecommunications cables in which the insulation and/or the sheath may contain the composition of the invention.

### DETAILED DESCRIPTION OF THE INVENTION

The invention will be better understood from the following examples of the composition and the method of the invention, given by way of non-limiting indication.

### EXAMPLE 1

The supramolecular polymer composition of the invention is obtained from the following ingredients:

a first polymer chain constituted by an EVA;

a first biurea carrying an alkoxysilane that reacts selectively with the first polymer chain;

a second polymer chain of the same EVA distinct from the first polymer chain; and

a second biurea carrying an alkoxysilane that is selectively reactive with the second polymer chain.

The fragmentary developed formula of each first and second EVA polymer chain is as follows:

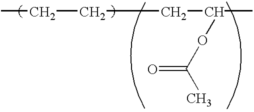

Each first and second monofunctional asymmetrical biurea is preferably a (2,6-diethylphenyl, 3-(dimethylethoxysilane)-propyl) ureido toluene having the 3-(dimethylethoxysilane)-propyl group that reacts selectively with EVA on one side and having the 2,6-diethylphenyl group on the other side that does not react with EVA. A spacer group corresponding to 1-methyl 2,4-phenylene is disposed between the two urea functions.

The developed formula for this biurea is written as follows:

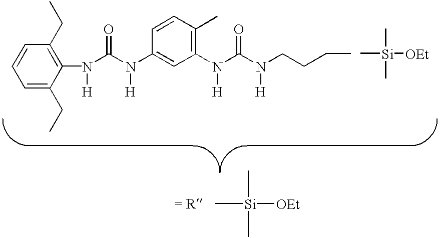

in which Et corresponds to an ethyl group. The non-developed formula of the biurea is R″SiOEt.

The grafting of the first biurea on the first EVA polymer chain, and of the second biurea on the second EVA polymer chain occur during compounding at a temperature lying in the range 140° C. to 210° C. in the presence of a catalyst based on tin such as dibutyltin dilaureate (DBTL).

The fragmentary formula of the biurea grafted EVA is as follows:

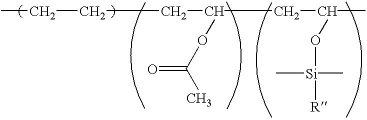

Self-association of the first biurea with the second biurea via at least one hydrogen bond (four hydrogen bonds in this example) also takes place during compounding.

Thereafter, while extruding without taking any special precautions, the two biureas can dissociate and then reassociate spontaneously after extrusion.

It is found that the thermomechanical properties and the resistance to creep or to deformation are good. Hardness on the Shore A scale is low, which is advantageous, particularly for applications in which the composition is used as a sheath or insulation for cables.

The composition can subsequently be reworked (extruded another time) at any time and its mechanical properties remain intact.

### EXAMPLE 2

In a manner analogous to Example 1, supramolecular polymer composition of the invention is obtained from the following ingredients:

a first polymer chain constituted by an EVA;

a first biurea carrying an alkoxysilane that reacts selectively with the first polymer chain;

a second polymer chain of the same EVA distinct from the first polymer chain;

a second biurea carrying an alkoxysilane that is selectively reactive with the second polymer chain; and

a third biurea without any group that is selectively reactive with EVA such as bis(2-ethylhexyl) ureido toluene corresponding to a symmetrical biurea having a non-reactive 2-ethyl hexyl group at each end and having the following developed formula:

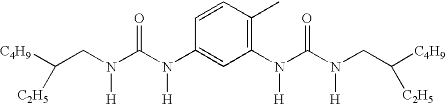

The grafting of the first biurea on the first EVA polymer chain and of the second biurea on the second EVA polymer chain then takes place during compounding.

The first biurea also associates with the second biurea via four hydrogen bonds during compounding, and the third biurea associates with the first and/or the second biurea via at least one hydrogen bond.

Thereafter, while extruding without taking any special precautions, the biureas can dissociate and reassociate spontaneously after extrusion.

The thermomechanical properties and the ability to withstand creep or deformation are good and hardness on the Shore A scale is low, which is advantageous, in particular for an application as a sheath or insulation for cables.

### EXAMPLE 3

In a manner analogous to Example 1, a supramolecular polymer composition of the invention is obtained from the following ingredients:

a first polymer chain of a polyethylene (PE);

a first biurea carrying a vinyl that is selectively reactive with the first polymer chain, such as the monofunctional asymmetrical biurea comprising a 4-nbutylphenyl group at one end and a reactive allyl group at the other end, having the following developed formula:

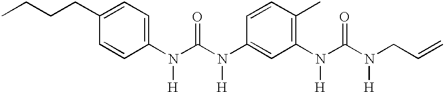

a second polymer chain of the same PE distinct from the first polymer chain; and

a second biurea carrying a vinyl that is selectively reactive with the second polymer chain, e.g. identical to the first biurea.

The grafting of the first biurea on the PE polymer chain and of the second biurea on the second PE polymer chain takes place during compounding in the presence of peroxide.

The first biurea also associates with the second biurea via four hydrogen bonds during compounding.

Thereafter, while extruding without taking any special precautions, the biureas can dissociate and then reassociate spontaneously after extrusion.

The thermomechanical properties and the ability to withstand creep or deformation are good and hardness on the Shore A scale is low, which is advantageous, particularly in an application as a sheath or insulation for cables.

### EXAMPLE 4

A supramolecular polymer composition of the invention is obtained from the following ingredients:

a first polymer chain of a silicone comprising a number m, where m is greater than or equal to 1, of hanging amine functions, e.g. having the following developed formula:

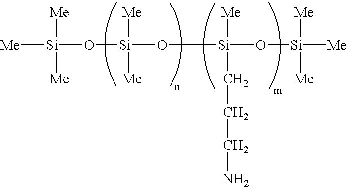

in which the Me groups correspond to methyl groups;

a first molecule with a group that is selectively reactive with the first polymer chain, for example a urea that is a precursor of the first biurea such as (BuP/NCO) monoisocyanate which comprises a urea and a 4-nbutylphenyl group with the following developed formula:

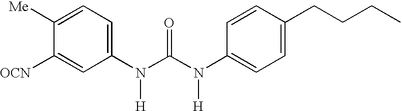

a second polymer chain of the same silicone distinct from the first polymer chain; and

a second molecule identical to the first molecule and constituting a precursor of a second biurea, comprising a group that is selective reactive with the second polymer chain.

The grafting of the first biurea on the first silicone polymer chain by the monoisocyanate reacting with one of the amine functions, and the grafting of the second biurea on the second silicone polymer chain by the monoisocyanate reacting with one of the amine functions takes place in solution in tetrahydrofuran (THF) at ambient temperature.

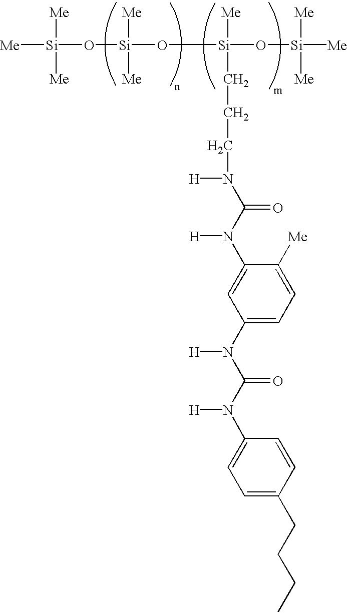

The first biurea self-associates with the second biurea via four hydrogen bonds during purification of the product.

Thereafter, while extruding without taking any special precautions, the first and second biureas can dissociate and then reassociate spontaneously after extrusion.

It is found that the thermomechanical properties and the ability to withstand creep or deformation are good. Hardness on the Shore A scale is low, which is advantageous, in particular in an application as a sheath or insulation for cables.

The composition can subsequently be reworked (extruded a second time) at any time and its mechanical properties are kept intact.

### EXAMPLE 5

A medium voltage power cable was made containing a supramolecular polymer composition obtained by the method of the invention. The sole FIGURE is a section through said power cable 100.

The power cable 100 comprises a conductive core 1 surrounded by an insulating structure I disposed coaxially thereabout. For example, this structure I comprises at least a first semiconductive layer 2 placed in contact with the core 1 of the cable 100, itself surrounded by a second layer 3 that is electrically insulating, in turn covered in a third layer 4 that is semiconductive. The outer layer 5 is a sheath which serves to protect the cable 100 and which contains the supramolecular polymer composition of the present invention.

Ingredients identical to those described in Example 1 can be mixed together in a mixer that is continuous or discontinuous, after which the composition is worked by extrusion. In this example, the material was moved by means of a screw from the feed zone to the die. The material plasticized under the action of blending driven by rotation of the screw and of heat delivered from the outside. Pressure rose progressively along the screw, thereby forcing the material to pass through the die and giving it a definitive shape at the outlet from the die. That technique can be used for covering copper wires or wires that have already been insulated by appropriately adapting the head of the die.

The composition constituting the sheath of the cable is capable of being reworked subsequently, i.e. of being extruded another time in order to form a new sheath, and this can take place at any time, e.g. after the cable has been in use for six or more months. The sheath made with the recycled composition retains mechanical properties that are similar to those of the original sheath since the initial properties of the ingredients of the invention are not spoilt.

Supramolecular polymer compositions of the invention also apply to insulating power cables for use at low, medium, high, and very high voltages, as well as to making protective sheaths not only for power cables (at low, medium, high, or very high voltages) but also for telecommunications cables.

1/ A supramolecular polymer composition comprising:
a first polymer chain on which at least one first functional group is grafted; and
a second polymer chain on which at least one second functional group is grafted;
said first and second functional groups being associated with each other by at least one intermolecular bond of the hydrogen type.

2/ A composition according to claim 1, further comprising a third functional group associated with at least one of said first and second functional groups by at least one intermolecular bond of the hydrogen type.

3/ A composition according to claim 1, said functional groups being selected from ureas, and preferably from biureas.

4/ A composition according to claim 3, wherein the biurea comprises a group known as a “spacer” group disposed between two urea functions, said spacer group being 1-methyl 2,4-phenylene.

5/ A composition according to claim 1, wherein said first functional group is identical to said second functional group.

6/ A composition according to claim 1, wherein each of said first and second polymer chains belongs to a polymer selected from: amorphous polymers; at least partially crystalline polymers; and preferably homopolymers of ethylene; copolymers of ethylene and vinyl acetate; and silicones.

7/ A composition according to claim 1, wherein:
said first functional group carries at least a first group that is selectively reactive with said first polymer chain;
said second functional group carries at least a second group that is selectively reactive with said second polymer chain;
said first and second reactive groups being selected from: alkoxysilanes; vinyls; silanes; epoxies; amines; and isocyanates.

8/ A composition according to claim 1, wherein:
said first functional group carries a first group that is selectively reactive with said first polymer chain;
said second functional group carries a second group that is selectively reactive with said second polymer chain;
said first and second reactive groups being selected from: alkoxysilanes; vinyls; silanes; epoxies; amines; and isocyanates.

9/ A composition according to claim 1, including a grafting catalyst selected from: amines; platinum-based compounds; and tin-based compounds, and preferably tin salts.

10/ A composition according to claim 1, further comprising at least one filler.

11/ A composition according to claim 1, comprising a first EVA polymer chain having at least a first biurea carrying an alkoxysilane grafted thereon, and a second EVA polymer chain having at least a second biurea carrying an alkoxysilane grafted thereon.

12/ A method of manufacturing a supramolecular polymer composition containing a plurality of functional groups, said method comprising:
a step of grafting a first of said functional groups on a first polymer chain, and a step of grafting a second of said functional groups on a second polymer chain; and
an “association” step of associating said first and second functional groups by at least one intermolecular bond of the hydrogen type.

13/ A method of manufacture according to claim 12, wherein said functional groups are selected from ureas and preferably from biureas, and wherein said first and second functional groups are preferably identical.

14/ A method of manufacture according to claim 12, wherein said grafting step is performed in the presence of a grafting catalyst selected from: amines; platinum-based compounds; and tin-based compounds, and preferably tin salts.

15/ A method of manufacture according to claim 12, wherein:
each of said first and second polymer chains belongs to a polymer selected from: elastomers; thermoplastic polymers; and preferably: homopolymers of ethylene; copolymers of ethylene and vinyl acetate; and silicones;
said first functional group comprises a first group that is selectively reactive with said first polymer chain; and
said second functional group comprises a second group that is selectively reactive with said second polymer chain;
said reactive groups preferably being identical and selected from: alkoxysilanes; vinyls; silanes; epoxies; amines; and isocyanates.

16/ A method of manufacture according to claim 12, wherein said grafting step is performed in the presence of peroxide.

17/ A method of manufacture according to claim 11, wherein at least one filler is added during one of said grafting and association steps.

18/ A cable having insulation and/or a sheath containing the supramolecular polymer composition obtained by the method according to claim 12.
